(19) United States
(12) Patent Application Publication
(10) Pub. No.: US 2023/0339365 A1
(43) Pub. Date: Oct. 26, 2023

(54) METHOD FOR OPERATING A FUEL CELL VEHICLE, AND FUEL CELL VEHICLE

(71) Applicant: AUDI AG, Ingolstadt (DE)

(72) Inventors: Markus RUF, Waldstetten (DE); Hannah STAUB, Karlsdorf-Neuthard (DE)

(21) Appl. No.: 17/925,585

(22) PCT Filed: May 18, 2021
(86) PCT No.: PCT/EP2021/063051

§ 371 Date: Nov. 15, 2022

(30) Foreign Application Priority Data
May 28, 2020 (DE) 102020114269.2

(51) Int. Cl. B60L 58/30; B60L 58/12

(52) U.S. Cl. CPC B60L 58/30; B60L 58/12; B60L 2240/12; B60L 2240/622

(57) ABSTRACT

A method for operating a fuel cell vehicle includes predictive determining of the anticipated running resistances on an upcoming stretch of road, detecting of parameters determining the performance capacity of a fuel cell device and a battery, determining of a velocity Vₛₒₗₗ which can be maintained uniformly over the upcoming stretch of road with the anticipated running resistances, and limiting of the power provided by the fuel cell vehicle to the value required in order to achieve the velocity Vₛₒₗₗ.

### BACKGROUND

### Technical Field

Embodiments of the invention relate to a method for operating a fuel cell vehicle. Embodiments of the invention furthermore relate to a fuel cell vehicle.

### Description of the Related Art

Fuel cell devices are used for the chemical transformation of a fuel into water, in order to generate electric energy. For this, fuel cells contain as their core component the so-called membrane electrode assembly, which is an assemblage of a proton-conducting membrane and an electrode arranged on either side of the membrane, namely, the anode and the cathode.

In operation of the fuel cell device having a plurality of fuel cells assembled into a fuel cell stack, the fuel, especially hydrogen H₂ or a hydrogen-containing gas mixture, is supplied to the anode, where an electrochemical oxidation of H₂ to H⁺ occurs, giving off electrons. Through the electrolyte or the membrane which electrically insulates the reaction spaces and separates them from each other in a gas-tight manner, a transport of protons H⁺ occurs from the anode space to the cathode space. The electrons provided at the anode are supplied via an electrical line to the cathode. The cathode is supplied with oxygen or an oxygen-containing gas mixture, so that a reduction of O₂ to O₂⁻ occurs, taking up electrons. At the same time, these oxygen anions react in the cathode space with the protons transported via the membrane to form water.

If such a fuel cell device is used in a fuel cell vehicle for the powering of an electrical traction motor, or also in hybrid vehicles as a range extender, there are requirements placed on the fuel cell device which change often and quickly. In a normal operating mode, the full power of the fuel cell device is constantly available, but on account of the boundary conditions a derating, or power reduction, may be required, in order to avoid damage to the fuel cell device or also to a battery.

In JP 2011232241 A a method is described for selecting a route in a battery-electric vehicle as a function of the state of charge by a navigation system. In JP 2005218178 A it is described how to evaluate, besides the state of charge for the driver's own battery, also consumption information from other vehicles having already traveled sections of the desired route. For a fuel cell vehicle, it is disclosed in DE 601 24 090 T2 how the fuel cell device can be operated at a predetermined nominal starting value and a difference in the energy consumption can be compensated by a battery, wherein the rate of change of the energy consumption is detected and the nominal starting value for the energy consumption is modified if the rate of change goes beyond a threshold value.

In event of steep ascents or intense heat, it may happen in vehicles having a fuel cell device that the initial power setting with the resulting velocity cannot be provided for the entire stretch of road, since the power already set for the fuel cell device and the battery is not enough, given the need to treat the components with care. The user of the vehicle then experiences a sudden speed decrease, which reduces customer acceptance or makes the customer think of a possible fault, with a possible panic reaction on dangerous sections of a passing maneuver or the possible need for roadside assistance or a repair shop.

### BRIEF SUMMARY

Some embodiments provide a method for operating a fuel cell vehicle with which the aforementioned drawbacks can be eliminated or at least mitigated. Some embodiments provide an improved fuel cell vehicle.

For example, one embodiment of a method for operating a fuel cell vehicle may include:
a) predictive determining of the anticipated running resistances on an upcoming stretch of road,
b) detecting of parameters determining the performance capacity of a fuel cell device and a battery,
c) determining of a velocity Vₛₒₗₗ which can be maintained uniformly over the upcoming stretch of road with the anticipated running resistances,
d) limiting of the power provided by the fuel cell vehicle to the value required in order to achieve the velocity Vₛₒₗₗ.

The aforementioned method offers the benefit that, given knowledge of the road already traveled and in dependence on the available power and state of charge of the battery, it is possible to determine a velocity curve along the road on which only a reduced velocity is enabled, so that there is no sudden drop in the power availability or the velocity which can be achieved with it. Given a suitable choice of Vₛₒₗₗ, a velocity decrease can be completely avoided. The most frequent application instance here is steep ascents, but the benefit is not limited to this, since the road quality for example can also affect the running resistances.

Environment parameters may be considered in the determining of the performance capacity according to step b), since intense heat with increased cooling demand can also affect the available power.

Data of a navigation system and/or traffic messages and/or the data of a weather service may be considered in the predictive determining of the running resistances. Thus, the available information on board a fuel cell vehicle is evaluated as comprehensively as possible, so that the value Vₛₒₗₗ can be determined precisely. Besides the data of the navigation device, traffic messages as to the traffic situation with traffic jam or stop and go traffic are meaningful, while the weather service gives an insight into head winds or side winds or the road quality.

A local controller of the fuel cell vehicle may be used to determine the velocity Vₛₒₗₗ and the power, as this affords an independent operation in this regard, although it is also conceivable to gather and/or evaluate data externally, e.g., in a cloud, but then an appropriate data traffic must be made possible.

A maximum velocity Vₘₐₓ may be calculated and enabled, since in this way the limitations are less noticeable to the user and an adequate safety margin remains, for example during passing maneuvers. The degradation status of the fuel cells can be considered in this calculation, so that a lower target velocity Vₘₐₓ may have to be dictated. But Vₘₐₓ can also be identical to Vₛₒₗₗ, that is, the appropriate velocity is available for the entire stretch of road. The user may also need to undertake interim settings for which speed reductions are permitted, for example on curves and tight turns or on especially steep sections of road.

The usage value and the user friendliness are improved when a repeat determination of Vₛₒₗₗ is done in an iterative manner while driving along the evaluated stretch of road for the rest of the upcoming stretch of road, and when the current traffic situation with the actual running resistances is considered while driving along the stretch of road.

It is also favorable when a traffic sign recognition is utilized for determining the running resistances, in order to take into account facts not known in the navigation systems, such as road work.

A charge of the battery may be considered when determining the velocity Vₛₒₗₗ, i.e., when the power consumption for the maintaining of Vₛₒₗₗ is determined such that a degradation of the battery is avoided or a degradation which has already occurred goes into the determination of the available power.

The aforementioned benefits and effects also hold accordingly for a fuel cell vehicle having a controller which is adapted to carry out the aforementioned method.

The features and combinations of features mentioned above in the specification and also the features and combinations of features mentioned below in the description of the figures and/or shown only in the figures can be used not only in the particular indicated combination, but also in other combinations or standing alone, without leaving the scope of the present disclosure. Thus, embodiments not explicitly shown or discussed in the figures, yet which emerge from and can be created from the explained embodiments by separate combinations of features should be seen as also being encompassed and disclosed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a fuel cell system of a fuel cell vehicle (shown schematically).

FIG. 2 shows a time-dependent representation of the attainable velocity for the case of a derating (broken line) and for the case of using methods described herein (solid line).

FIG. 3 shows a time-dependent representation of the state of charge (SOC) of the battery for the case of a derating (broken line) and for the case of using methods described herein (solid line).

### DETAILED DESCRIPTION

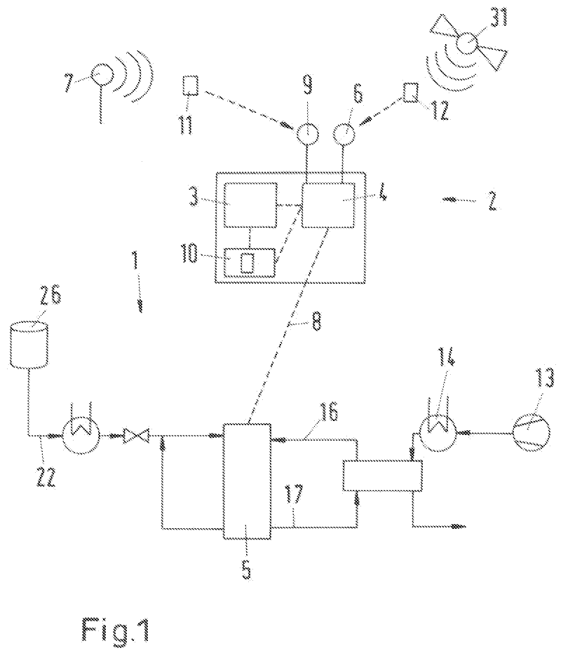

FIG. 1 shows a fuel cell device 1 connected by a communication link 8 to a navigation system 2, comprising a fuel cell stack 5, having a plurality of fuel cells connected in series. The fuel cell device 1 and the navigation system 2 are part of a fuel cell vehicle, not otherwise shown.

Each of the fuel cells comprises an anode, a cathode, and a proton-conducting membrane separating the anode from the cathode. The membrane is formed from an ionomer, such as a sulfonated polytetrafluorethylene polymer (PTFE) or a polymer of perfluorinated sulfonic acid (PFSA). Alternatively, the membrane can also be formed as a sulfonated hydrocarbon membrane.

Through an anode space, the anode can be supplied with fuel (for example, hydrogen) from a fuel tank. In a polymer electrolyte membrane fuel cell (PEM fuel cell), fuel or fuel molecules are split up into protons and electrons at the anode. The PEM allows the protons to pass through, but it is impermeable to the electrons. At the anode, the reaction occurs for example: 2H₂→H⁺+4e⁻ (oxidation/electron surrender). While the protons pass through the PEM to the cathode, the electrons are taken by an external circuit to the cathode or to an energy accumulator.

Through a cathode space, the cathode gas (for example oxygen or air containing oxygen) can be supplied, so that the following reaction occurs at the cathode side: O₂+4H⁺+4e⁻→2H₂O (reduction/electron uptake).

The fuel cell device 1 shown supplies electric power to at least one drive motor of the fuel cell vehicle. In addition, there is also present a battery, not otherwise shown, for the electrical powering of the drive motor, so that a hybrid system of fuel cell and battery is at hand, in which the available power is determined by the cooperation of the fuel cell device 1 and the battery and during high power demand which cannot be handled by the fuel cell device 1 alone the battery can also be used. It should be noted that during high power demand, such as passing maneuvers, the power output of the fuel cell device 1 must be limited for thermal reasons and thus the velocity selected in the valley cannot be maintained. In order to avoid the associated drawbacks, especially those for the user or in the perception of the user, a method can be used which involves the following steps:
a) predictive determining of the anticipated running resistances on an upcoming stretch of road,
b) detecting of parameters determining the performance capacity of a fuel cell device 1 and a battery, and optionally the waste heat,
c) determining of a velocity Vₛₒₗₗ which can be maintained uniformly over the upcoming stretch of road with the anticipated running resistances,
d) limiting of the power provided by the fuel cell vehicle to the value required in order to achieve the velocity Vₛₒₗₗ.

Advisedly, environment parameters are also considered in the determining of the performance capacity according to step b), such as the temperature and the altitude.

The accuracy in the determination of Vₛₒₗₗ is improved by considering the data of a navigation system 2 and/or of traffic messages 7 and/or of a weather service 11 during the predictive determination of the running resistances.

The data detected are evaluated by a local controller 10 of the fuel cell vehicle for the determination of the velocity Vₛₒₗₗ and the power.

In addition, a maximum velocity Vₘₐₓ can also be calculated and enabled, wherein a repeat determination of Vₛₒₗₗ can be done in an iterative manner while driving along the evaluated stretch of road for the rest of the upcoming stretch of road and the current traffic situation with the actual running resistances is considered while driving along the stretch of road and a traffic sign recognition is utilized for determining the running resistances. In addition, the charge of the battery can also be considered when determining the velocity Vₛₒₗₗ.

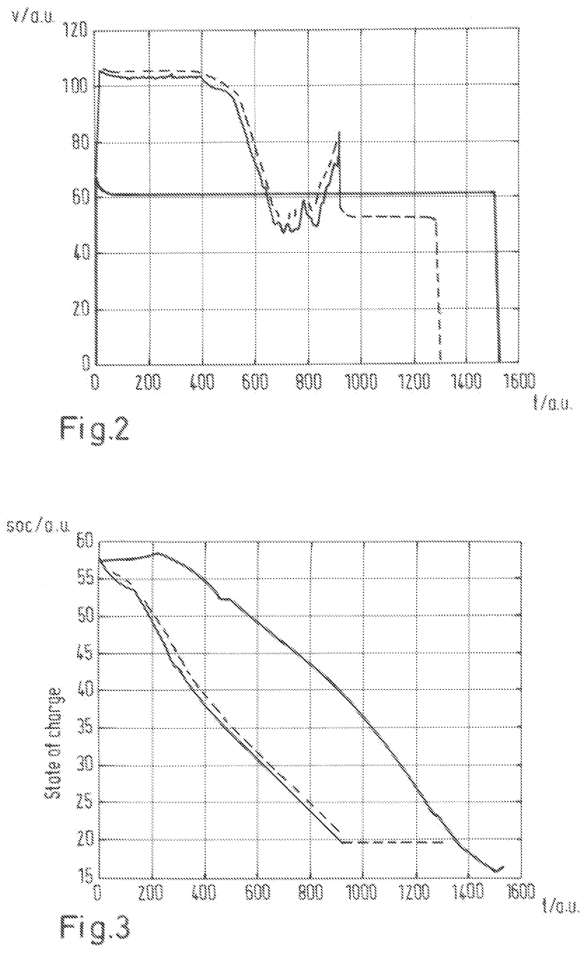

FIG. 2 makes clear the effect of the methods described herein. The broken line shows the abrupt velocity decrease which must occur due to a derating with empty battery, yet which is avoided in accordance with the solid line when the velocity has already been limited in advance, so that the available power is put out uniformly for the entire period of time. FIG. 3 shows the effect of the method on the state of charge of the battery, which is needed less in addition for the providing of the power of the fuel cell device.

### LIST OF REFERENCE NUMBERS

1 Fuel cell device
2 Navigation system
3 Route determination device
4 Data reception device
5 Fuel cell stack
6 GPS sensor
7 Traffic messages
8 Communication link
9 Sensor
10 Controller
11 Weather service for weather data
12 Position data
13 Compressor
14 Intercooler
15 Humidifier
16 Cathode supply line
17 Cathode exhaust gas line
19 Exhaust gas line
22 Anode supply line
26 Fuel storage

Aspects of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a fuel cell vehicle, comprising:
predictively determining anticipated running resistances on an upcoming stretch of road,
detecting parameters determining a performance capacity of a fuel cell device and a battery,
determining a velocity Vₛₒₗₗ which can be maintained uniformly over the upcoming stretch of road with the anticipated running resistances, and
limiting power provided by the fuel cell vehicle to a value required to achieve the velocity Vₛₒₗₗ.

2. The method according to claim 1, wherein environment parameters are considered in the determining of the performance capacity.

3. The method according to claim 1, wherein data of a navigation system and/or traffic messages and/or the data of a weather service are considered in the predictive determining of the running resistances.

4. The method according to claim 1, wherein a local controller of the fuel cell vehicle is used to determine the velocity Vₛₒₗₗ and the power.

5. The method according to claim 1, wherein a maximum velocity Vₘₐₓ is calculated and enabled.

6. The method according to claim 1, wherein a repeat determination of Vₛₒₗₗ is done in an iterative manner while driving along the evaluated stretch of road for the rest of the upcoming stretch of road.

7. The method according to claim 6, wherein the current traffic situation with the actual running resistances is considered while driving along the stretch of road.

8. The method according to claim 7, wherein a traffic sign recognition is utilized for determining the running resistances.

9. The method according to claim 1, wherein a charge of the battery is considered when determining the velocity Vₛₒₗₗ.

10. A fuel cell vehicle having a controller which is adapted to carrying out a method of operating a fuel cell vehicle, the method comprising:
predictively determining anticipated running resistances on an upcoming stretch of road,
detecting parameters determining a performance capacity of a fuel cell device and a battery,
determining a velocity Vₛₒₗₗ which can be maintained uniformly over the upcoming stretch of road with the anticipated running resistances, and
limiting power provided by the fuel cell vehicle to a value required to achieve the velocity Vₛₒₗₗ.
